(19) United States
(12) Patent Application Publication
(10) Pub. No.: US 2006/0155032 A1
(43) Pub. Date: Jul. 13, 2006

(54) Fluororesin composition

(75) Inventors: Kazuo Mizubuchi, Shizuoka (JP); Hiroshi Tanimura, Osaka (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignees: DU PONT-MITSUI FLUOROCHEMICALS CO., LTD., Tokyo (JP); MATSUSHITA ELECTRIC INDUSTRIAL CO., LTD., Kadoma-shi (JP)

(21) Appl. No.: 10/540,585

(22) PCT Filed: Dec. 26, 2003
(86) PCT No.: PCT/JP03/17007

§ 371 Date: Jun. 27, 2005

(30) Foreign Application Priority Data
Dec. 27, 2002 (JP) 2002-379066

(51) Int. Cl. C08K 3/22

(52) U.S. Cl. 524/432

(57) ABSTRACT

To provide resin compositions suitable for molding sliding parts that have lubricity and the heat-resistant property and further show excellent friction and wearing resistances and compression creeping resistance. The fluororesin compositions comprise a tetrafluoroethylene polymer, zinc oxide whisker and granular fillers having average particle size of not more than 200 μm and/or fibrous fillers having average fiber length of not more than 500 μm. Preferable zinc oxide whisker contains tetrapod-shape one. Preferable fillers are at least one selected from carbon fiber, coke powder, graphite powder, bronze powder, copper powder, zinc oxide powder, talc and glass fiber.

### TECHNICAL FIELD

The present invention relates to a fluororesin composition suitable for molding of sliding mechanic parts etc. In more precisely it relates to a fluororesin composition which has lubricity, and further superior friction and wearing resistance and compression creep resistance.

### TECHNICAL BACKGROUND

In the field of precision machines such as computer-related devices, office equipment or audio visual system related devices, etc., much plastic products having sliding property are used for parts such as gears, bearings, sleeves, rolls, rails. In the past, such sliding parts were molded using a thermoplastic resin such as polyolefin, polyamide, fluororesin, ABS resin and polyphenylene sulfide; a thermosetting resin such as epoxy resin and phenolic resin; or a resin composition combined filler such as glass fiber, carbon fiber and mica with such resins for raw materials, and various shapes of products have been produced.

However, as use conditions of those parts become severe, parts which have not only lubricity and heat resistance but also is hard to be worn due to friction and is hard to be deformed even under strong stress have been demanded. By the way, there is a description that resin composition containing zinc oxide whisker as filler can be used for molding materials of electricity parts because it is superior in static electricity diffusion property and sliding property, in Japanese Patent No. 3041071. However, from a point of view to wearing resistance and compression creep resistance, more improvement to the molded materials is demanded.

### DISCLOSURE OF THE PRESENT INVENTION

The object of the present invention is to provide a resin composition suitable for molding of sliding parts that have lubricity and heat-resistant property and is further superior in friction and wearing resistance and compression creep resistance.

The present invention relates to a fluororesin composition comprising tetrafluoroetylene polymer, zinc oxide whisker and granular filler having average particle size of not more than 200 μm and/or fibrous filler having average fiber length of not more than 500 μm.

In the resin composition, the composition comprising 20-90% by weight of the tetrafluoroethylene polymer, 5-40% by weight of the zinc oxide whisker and 2-40% by weight of the filler, wherein total quantity of three components is 100% by weight, is preferable embodiment.

Such a resin composition is superior in lubricity, heat-resistance, abrasion resistance to friction and compression creep resistance.

### PREFERABLE EMBODIMENTS TO IMPLEMENT THE PRESENT INVENTION

The present invention provides a fluororesin composition comprising tetrafluoroethylene polymer, zinc oxide whisker, and granular filler having average particle size of not more than 200 μm and/or fibrous filler having average fiber length of not more than 500 μm.

The tetrafluoroethylene polymer used in the present invention is homopolymer of tetrafluoroethylene (TFE) or tetrafluoroethylene copolymer obtained by copolymerizing TFE with copolymerizable monomers in the amount of not more than 1.0% by weight. As the copolymerizable monomers, there can be used perfluoroalkene having 3 to 6 carbon atoms such as hexafluoro propylene; perfluoro (alkyl vinyl ether) containing alkyl groups having 1 to 6 carbon atoms such as perfluoro (propyl vinyl ether); or chlorotrifluoroethylene, etc.

Both homopolymer and the above-mentioned copolymer of TFE do not have melt-processability under usual meltprocessing conditions because they have high melting point.

The tetrafluoroethylene polymer can be used as molded articles for sliding parts, electric and electronic parts, packing materials, etc. as far as it has the molecular weight that can be molded with compression molding and others. For example, when the property is shown by melting point instead of molecular weight, polymer having melting point of about 327° C. can be used suitably as molding resin for sliding parts which show good mechanical strength and heat resistance.

In addition, the tetrafluoroethylene polymers are used normally in powder state for molding of various products. And the average particle size of the tetrafluoroethylene polymer is desirably in a range of not more than 100 μm, preferably 5 to 100 μm, more preferably 10 to 50 μm.

The tetrafluoroethylene polymer having average particle size in the above range is superior in uniform mixing with the zinc oxide whisker and various types of fillers. Such a tetrafluoroethylene polymer can be produced as powder directly by suspension polymerization or emulsion polymerization, and may be produced by pulverizing pellet, that has been once pelletized after polymerization, to form powder having average particle size of not more than 100 μm. In addition, powder of commercial molding grade can be used when it has above average particle size.

In the zinc oxide whisker of the present invention, there is no particular limitation in the production method and shape. Giving one of examples, it can be produced by heat-treating the metal zinc powder having an oxidated membrane on its surface under atmosphere containing oxygen. Thus obtained whisker presents the shape of so-called tetrapod-shaped that needle-shaped crystal was expanded from a center of tetrahedron toward four directions. Length of the needle-shaped part is preferably 3-200 μm and a base part diameter of needle-shaped part is preferably 0.1-10 μm.

Zinc oxide whisker containing such a tetrapod-shaped whisker is preferable because it does not affect to properties such as lubricity, wearing resistance or compression creep resistance even when a needle-shaped part is partially damaged during mixing with each component constituting the resin composition or during molding the resin composition.

Further, the surface of the zinc oxide whisker can be treated with a silane-based, a chrome-based or a titanium-based coupling agent. When the surface of the zinc oxide whisker is treated with the silane-based coupling agent in particular, dispersibility of the whisker into tetrafluoroethylene polymer particle can be improved. Such a tetrapod-shaped zinc oxide whisker is commercially available in the market, for example, with trade name of Pana-Tetra from Matsushita Electric Industrial Co., Ltd., and can be obtained and used easily.

The above mentioned zinc oxide whisker contributes to formation of composition having low anisotropy strengthened three dimensionally by the peculiar shape, and the molded articles showing good dimensional stability can be produced from the composition.

In addition, since the zinc oxide whisker itself shows good electroconductivity and thermalconductivity, it can effectively radiate frictional heat generated when the molded articles is slid. It seems that the feature of the zinc oxide whisker is combined with various characteristics of other fillers used together to generate synergistic effects and consequently enhance friction and wearing resistance and compression creep resistance.

Furthermore, the Mohs hardness degree of the zinc oxide whisker is about 4 and this shows zinc oxide comparatively soft material, so it is possible to reduce wear of partner soft material and also to reduce self wear, and further to prevent a performance decline due to the damage caused by extrusion deformation of the articles.

In the present invention, the filler combined with the tetrafluoroethylene polymer in conjunction with zinc oxide whisker is inorganic substances or organic substances, and has the average particle size of not more than 200 μm, preferably 2 to 50 μm and/or average fiber length of not more than 500 μm.

As preferable examples of the fillers of the present invention, at least one substance selected from the group of carbon fiber, coke powder, graphite powder, bronze powder, copper powder, zinc oxide powder, talc, glass fiber, molybdenum disulfide, a polyamide, an aromatic polyamide, polyphenylene sulfide. Above all, a carbon fiber, coke powder, graphite powder, bronze powder, copper powder, zinc oxide powder, talc, glass fiber are preferable. In the present invention, if fillers have the above average particle size and/or the average fiber length, commercially available products can be used as they are.

As for ratios of each component constituting resin compositions, it is desirable that the tetrafluoroethylene polymer is preferably in the range of 20-90% by weight, more preferably 25-80% by weight, the zinc oxide whisker is preferably in the range of 5-40% by weight, more preferably 10-30% by weight and the filler is preferably in a range of 2-40% by weight, more preferably 10-35% by weight. Total quantity of above three components becomes 100% by weight here. When each component is in the above range, the resin composition showing excellent superior friction and wearing resistance and compression creep resistance while retaining good lubricity can be obtained, and the compositions are suitable for molding of sliding parts.

Stabilizers and additives such as anti-oxidants, thermal stabilizers, weather stabilizers, flame retardants, pigments can be combined with the resin compositions to the extent that they do not impair the object of the present invention.

By mixing powder uniformly, to which the above stabilizers or additives are added as required, with three components of the present invention using conventionally known mixing device such as Henshel mixer, powdery resin composition can be obtained.

From such a powdery resin composition, various sliding parts as required can be produced by compression molding method or extrusion molding method.

For example, the above resin composition is preformed by compression molding method and sintered at the temperature over melting point of the tetrafluoroethylene polymer to form molded materials. Then the materials are shaped by curving etc. in accordance with the required article to form the final parts.

Since the resin compositions of the present invention are composed with the zinc oxide whisker and at least one kind of fillers are dispersed uniformly in the tetrafluoroethylene polymer, the resin composition maintains good lubricity and further shows excellent friction and wearing resistance and compression creeping resistance.

In addition, the resin compositions have stable static electricity diffusibility and are suitable as raw resin materials for various kinds of sliding parts, electric and electronic parts, packing materials, etc.

### EXAMPLES

The present invention will be explained by using examples in more detail but it is not limited to the examples.

At first, raw materials used are shown below.

(a) Tetrafluoroethylene homopolymer: It is abbreviated PTFE.

Average particle size 35 μm, Melting point 327° C.

Product from DuPont·Mitui Fluorochemicals Co, Ltd.
Grade name: Teflon (registered trade mark) 7-J
   (b) Zinc oxide whisker:

Diameter of a needle-shaped staple fiber 0.2 to 30 μm,

Length of a needle-shaped staple fiber 2 to 50 μm.

Product from Matsushita Electric Industrial Co., Ltd.

Trade name: Pana-Tetra

(c) Carbon fiber:

Average fiber diameter 14.5 μm, Average fiber length 120 μm

Product from Kureha Chemical Industry Co. Ltd.

(d) Copper powder:

Average particle size 26 μm

Product from Fukuda Metal Foil & Powder Co. Ltd.

(e) Graphite powder:

Average particle size 20 μm

Product from Oriental Sangyo Co. Ltd.

(f) Cokes powder:

Average particle size 20 μm

Product from Nippon Carbon Co. LTD

(g) Glass fiber:

Average fiber diameter 10.5 μm, Average fiber length 20 μm

Nitto Boseki Co. Ltd.

### Examples 1 to 5 Comparative Examples 1 to 5

The tetrafluoroethylene homopolymer, zinc oxide whisker and various fillers are used at table 1 and they mixed uniformly using Henshell mixer to obtain the resin compositions.

Each resin composition obtained was preformed under pressure of 700 MPa and then sintered at 370° C. for three hours to obtain a cylinder-shaped molded article of a diameter of 50 mm height of 100 mm.

Wearing loss, compression creeping property and sliding temperature of each molded article were measured by test methods mentioned below and the results are shown in Table 1.

(1) Wearing Loss:

A ring having outer diameter of 25.7 mm, inner diameter of 20 mm and height of 20 mm is prepared from the cylinder-shaped molded article mentioned above and used as a specimen for the test. Wearing loss of the specimen was measured using twin type friction and wearing tester (product from INTESCO Co. Ltd.) in accordance with JIS K7218 (A method). Measurement of wearing loss was conducted by sliding for 24 hours under each wearing test conditions of the partner material, the load and the sliding speed described in table 1. The wearing loss after the test is calculated from coefficient of wearing and coefficient of frictional.

(2) Compression Creeping Property:

A cube having side length of 12.7 mm was prepared by curving the above cylinder-shaped molded article and was used as a test specimen.

Compression creeping property was measured using six-liked compression creeping tester (product from ORIENTEC Co., Ltd.) in accordance with ASTM D-621 under conditions of measurement temperature at 23° C. and load of 140 kgf/cm². In table 1, MD shows a compression direction, and CD shows a vertical direction which is a right angle to the compression direction.

Values of deformation show the rests of value that quantity of recovery after 24 hours was deducted from all volume of deformation.

(3) Sliding Temperature:

A tip of thermocouple was set on about 2 mm upper parts from the sliding side of the partner material using EFM-3F type machine produced by ORIENTEC Co. Ltd. and measurement was conducted. Table 1

TABLE 1

| | | | | | | Comp. |
|---|---|---|---|---|---|---|
| | Ex. 1 | Ex. 2 | Ex. 3 | Ex. 4 | Ex. 5 | Ex. 1 |
| Resin composition (wt %) | | | | | | |
| PTFE | 80.0 | 70.0 | 55.0 | 57.0 | 70.0 | 100 |
| Zinc oxide whisker | 10.0 | 15.0 | 20.0 | 10.0 | 10.0 | — |
| Carbon fiber | 10.0 | 15.0 | 10.0 | — | — | — |
| Copper powder | — | — | 15.0 | — | — | — |
| Cokes powder | — | — | — | 31.0 | — | — |
| Graphite | — | — | — | 2.0 | — | — |
| Grass fiber | — | — | — | — | 20.0 | — |
| Wearing test result | | | | | | |
| Test condition | | | | | | |
| Partner material (*) | ADC-12 | ADC-12 | ADC-12 | FC-25 | SS-41 | ADC-12 |
| Load (kg/cm²) | 8.0 | 8.0 | 8.0 | 6.0 | 6.0 | 8.0 |
| Sliding speed (m/s) | 0.5 | 0.5 | 0.5 | 0.5 | 0.5 | 0.5 |
| Wearing coefficient (**) (×10⁸) | 14.2 | 11.5 | 4.8 | 9.0 | 7.2 | 2791 |
| Friction coefficient (**) | 0.226 | 0.193 | 0.255 | 0.288 | 0.36 | 0.185 |
| A sliding temperature (° C.) | 76 | 75 | 83 | 78 | 93 | 73 |
| Compression creeping | | | | | | |
| test result (%) | | | | | | |
| 24 hours deform (MD) | 6.4 | 4.9 | 3.5 | 3.5 | 11.2 | 14.0 |
| 24 hours deform (CD) | 7.6 | 5.3 | 3.2 | 3.1 | 13.3 | 15.8 |
| Eternity deformation (MD) | 3.2 | 2.6 | 1.7 | 1.7 | 6.5 | 7.6 |
| Eternity deformation (CD) | 3.9 | 2.9 | 1.7 | 1.4 | 7.8 | 8.6 |

| | Comp. | Comp. | Comp. | Comp. | Comp. | Comp. |
|---|---|---|---|---|---|---|
| | Ex. 2 | Ex. 3 | Ex. 4 | Ex. 5 | Ex. 6 | Ex. 7 |
| Resin composition (wt %) | | | | | | |
| PTFE | 90.0 | 80.0 | 90.0 | 70.0 | 67.0 | 80.0 |
| Zinc oxide whisker | 10.0 | 20.0 | — | — | — | — |
| Carbon fiber | — | — | 10.0 | 15.0 | — | — |
| Copper powder | — | — | — | 15.0 | — | — |
| Cokes powder | — | — | — | — | 31.0 | — |
| Graphite | — | — | — | — | 2.0 | — |
| Grass fiber | — | — | — | — | — | 20.0 |
| Wearing test result | | | | | | |
| Test condition | | | | | | |
| Partner material (*) | ADC-12 | ADC-12 | ADC-12 | ADC-12 | FC-25 | SS-41 |
| Load (kg/cm²) | 8.0 | 8.0 | 8.0 | 8.0 | 6.0 | 6.0 |
| Sliding speed (m/s) | 0.5 | 0.5 | 0.5 | 0.5 | 0.5 | 0.5 |
| Wearing coefficient (**) (×10⁸) | 14.1 | 5.9 | 46.0 | 12.1 | 49.3 | 12.6 |
| Friction coefficient (**) | 0.203 | 0.285 | 0.252 | 0.244 | 0.348 | 0.37 |
| A sliding temperature (° C.) | 80-82 | 88-90 | 95 | 85 | 133 | 143 |
| Compression creeping | | | | | | |
| test result (%) | | | | | | |
| 24 hours deform (MD) | 11.0 | 7.7 | 9.4 | 5.8 | 4.9 | 12.4 |
| 24 hours deform (CD) | 12.1 | 9.5 | 13.2 | 6.0 | 3.9 | 13.7 |
| Eternity deformation (MD) | 6.4 | 4.3 | 5.1 | 3.1 | 1.8 | 7.1 |
| Eternity deformation (CD) | 6.9 | 5.7 | 7.1 | 3.0 | 1.8 | 8.2 |

(*) Partner material: ADC-12 [An aluminum alloy die-casting JIS H5302(1976)]
FC [4 kinds of Gray cast iron JIS G5501(1976)]
SS-41 [Rolled steel materials for general structure JIS G3101(1976)]
(**) Unit of Friction coefficient and wearing coefficient: cm³ · sec/kg · m · hr

As clear from the results of table 1, it is found that since the resin composition of each Examples comprising the tetrafluoroethylene polymer, the zinc oxide whisker and the fillers has extremely good thermal conductivity by contribution of a zinc oxide whisker comparing with resin compositions of each comparative examples that consisted of a tetrafluoroethylene polymer alone or with various fillers, the sliding temperature can be lowered, the coefficient of friction keeps constantly low and the wearing coefficient becomes smaller, and compression creeping property shows a small value.

### APPLICABILITY TO INDUSTRIES

By the present invention, the resin compositions suitable for molding of sliding parts and others that have lubricity and thermal-resistant property and are further superior in friction and wearing resistance and compression creep resistance.

The resin compositions obtained by the present invention are superior in lubricity, thermal-resistance, friction and wearing resistances and compression creep resistance.

Since the resin compositions of the present invention have the construction that the zinc oxide whisker and at least one kind of fillers are dispersed uniformly in the tetrafluoroethylene polymer, the resin compositions maintain good lubricity and further shows excellent friction and wearing resistances and compression creeping resistance. Therefore the resin compositions have stable static electricity diffusibility and are suitable as resin materials resin for various kinds of sliding parts, electric and electronic parts, packing materials, etc.

1. A fluororesin composition which comprises a tetrafluoroethylene polymer, zinc oxide whisker and granular filler having average particle size of not more than 200 μm and/or fibrous filler having average fiber length of not more than 500 μm which is at least one kind of substance selected from the group consisting of carbon fiber, coke powder, graphite powder, bronze powder, copper powder, zinc oxide powder, talc, glass fiber, molybdenum disulfide, polyamide, aromatic polyamide and polyphenylene sulfide.

2. The fluororesin compositions according to claim 1, wherein the resin compositions contain 20-90% by weight of the tetrafluoroethylene polymer, 5-40% by weight of the zinc oxide whisker and 2-40% by weight of filler, and total quantity of above three components becomes 100% by weight.

3. The fluororesin compositions according to claim 2, wherein the zinc oxide whisker contains a tetrapod-shape.

4.-5. (canceled)

6. The fluororesin compositions according to claim 1 wherein the zinc oxide whisker contains a tetrapod-shape.
